(19) United States
(12) Patent Application Publication
(10) Pub. No.: US 2025/0341049 A1
(43) Pub. Date: Nov. 6, 2025

(54) MANUFACTURING METHOD OF WEAR-RESISTANT ARTIFICIAL LEATHER

(71) Applicant: SAN FANG CHEMICAL INDUSTRY CO., LTD., KAOHSIUNG CITY (TW)

(72) Inventors: CHIH-YI LIN, Kaohsiung City (TW); Kuo-Kuang Cheng, Kaohsiung City (TW); Chi-Chin Chiang, Kaohsiung City (TW); Kun Lin Chiang, Kaohsiung City (TW); Kuo-Li Lo, Kaohsiung City (TW); Yuan-Jhong Wu, Kaohsiung City (TW)

(21) Appl. No.: 19/178,267

(22) Filed: Apr. 14, 2025

(30) Foreign Application Priority Data
May 6, 2024 (TW) 113116675

(51) Int. Cl. D06N 3/00; B32B 7/12; B32B 27/08; B32B 27/16; B32B 27/32; B32B 27/40; D06N 3/04; D06N 3/14; D06N 3/18

(52) U.S. Cl. CPC D06N 3/0097; B32B 7/12; B32B 27/08; B32B 27/16; B32B 27/32; B32B 27/40; D06N 3/0056; D06N 3/0084; D06N 3/045; D06N 3/14; D06N 3/183; B32B 2255/26; D06N 2207/14

(57) ABSTRACT

A manufacturing method of a wear-resistant artificial leather includes forming a modified thermoplastic polyolefin film and laminating the modified thermoplastic polyolefin film onto a substrate to form a first laminate structure, forming a polyurethane layer on a release paper and then forming an adhesive layer on the polyurethane layer to form a second laminate structure, attaching the adhesive layer of the second laminate structure to the modified thermoplastic polyolefin film of the first laminate structure, removing the release paper to expose the polyurethane layer, and forming a silicon-containing water-based polyurethane surface layer on the polyurethane layer to obtain the wear-resistant artificial leather.

### BACKGROUND

### 1. Field of the Disclosure

The present disclosure relates to the technical field of artificial leather, and more particularly, to a manufacturing method of a wear-resistant artificial leather.

### 2. Description of the Related Art

With the widespread use of artificial leather, the requirements for the leather used in automotive interiors are no longer limited to high thermal aging resistance and low-temperature bending resistance; there is also an increasing demand for wear resistance. However, the manufacturing methods of artificial leather in existing technologies generally result in products with poor wear resistance.

Therefore, it is necessary to improve the manufacturing methods of artificial leather using existing technologies to address the issues mentioned above.

### SUMMARY

In some embodiments of the present disclosure, a manufacturing method of a wear-resistant artificial leather includes forming a modified thermoplastic polyolefin film and laminating the modified thermoplastic polyolefin film onto a substrate to form a first laminate structure, forming a polyurethane layer on a release paper and then forming an adhesive layer on the polyurethane layer to form a second laminate structure, attaching the adhesive layer of the second laminate structure to the modified thermoplastic polyolefin film of the first laminate structure, removing the release paper to expose the polyurethane layer, and forming a silicon-containing water-based polyurethane surface layer on the polyurethane layer to obtain the wear-resistant artificial leather.

Compared to existing technologies, the manufacturing method of the present disclosure produces wear-resistant artificial leather with at least the following technical effects: wear resistance can reach 30,000 cycles, and the peeling strength can be increased to 15.0 nt/cm.

### BRIEF DESCRIPTION OF THE DRAWINGS

Aspects of some embodiments of the present disclosure are readily understood from the following detailed description when read with the accompanying figures. It is noted that various structures may not be drawn to scale, and dimensions of the various structures may be arbitrarily increased or reduced for clarity of discussion.

FIG. 1 illustrates a schematic view of one or more stages of some embodiments of a manufacturing method of a wear-resistant artificial leather according to the present disclosure.

FIG. 2 illustrates a schematic view of one or more stages of some embodiments of a manufacturing method of a wear-resistant artificial leather according to the present disclosure.

FIG. 3 illustrates a schematic view of one or more stages of some embodiments of a manufacturing method of a wear-resistant artificial leather according to the present disclosure.

FIG. 4 illustrates a schematic view of one or more stages of some embodiments of a manufacturing method of a wear-resistant artificial leather according to the present disclosure.

FIG. 5 illustrates a schematic view of one or more stages of some embodiments of a manufacturing method of a wear-resistant artificial leather according to the present disclosure.

FIG. 6 illustrates a schematic view of one or more stages of some embodiments of a manufacturing method of a wear-resistant artificial leather according to the present disclosure.

FIG. 7 illustrates a schematic view of one or more stages of some embodiments of a manufacturing method of a wear-resistant artificial leather according to the present disclosure.

### DETAILED DESCRIPTION

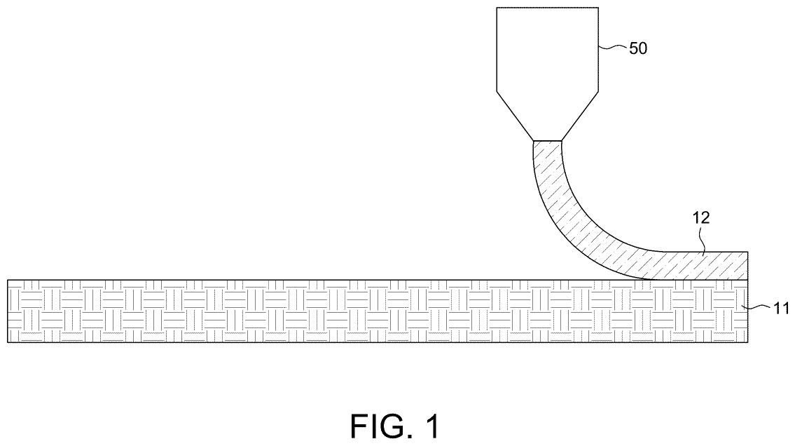

FIGS. 1 to 7 illustrate one or more stages of some embodiments of a manufacturing method of a wear-resistant artificial leather according to the present disclosure.

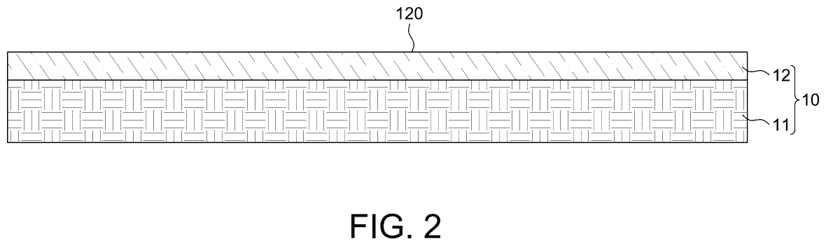

Referring to FIG. 1 and FIG. 2, a modified thermoplastic polyolefin film 12 is formed by a co-extrusion die head 50, and the modified thermoplastic polyolefin film 12 is laminated onto a substrate 11 (FIG. 1) to form a first laminate structure 10 (FIG. 2). In some embodiments of the present disclosure, the substrate 11 may include, but is not limited to, non-woven fabric, woven fabric (including, for example, knitted fabric and plain woven fabric), or microfiber. In some embodiments of the present disclosure, the knitted fabric may include, but is not limited to, warp-knitted fabric, circular knitted fabric, or brushed fabric.

In some embodiments of the present disclosure, the modified thermoplastic polyolefin film 12 may be a blend of thermoplastic polyolefin and maleic anhydride. In some embodiments of the present disclosure, a thickness of the modified thermoplastic polyolefin film 12 may be 0.18 mm to 0.22 mm.

In some embodiments of the present disclosure, after forming the first laminate structure 10, surface corona treatment can be performed on the modified thermoplastic polyolefin film 12 so that a surface tension of a corona-treated surface 120 of the modified thermoplastic polyolefin film 12 can be greater than or equal to 45 dynes. In some embodiments of the present disclosure, a corona power of the corona treatment may be 2 KW to 5 KW.

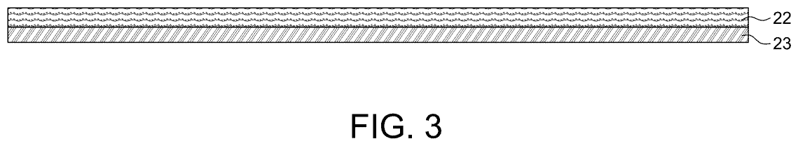

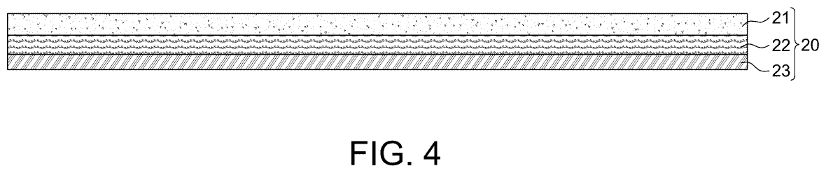

Referring to FIG. 3 and FIG. 4, a polyurethane layer 22 is formed on a release paper 23 using a coating method (FIG. 3), and then an adhesive layer 21 is formed on the polyurethane layer 22 to form a second laminate structure 20 (FIG. 4). The polyurethane layer 22 may be configured to provide surface color changes and patterns. In some embodiments of the present disclosure, the polyurethane layer 22 may be an oil-based polyurethane layer. In some embodiments of the present disclosure, the polyurethane layer 22 may be a mixture of thermosetting polyurethane, color paste, and a crosslinking agent. In some embodiments of the present disclosure, a content of the crosslinking agent may be 1 wt % to 3 wt %. In some embodiments of the present disclosure, the crosslinking agent may also be referred to as a “crosslinker” or “hardener.” In some embodiments of the present disclosure, the polyurethane layer 22 may further include a light-absorbing agent. In some embodiments of the present disclosure, the polyurethane layer 22 may be a single-layer or multi-layer structure. In some embodiments of the present disclosure, a thickness of the polyurethane layer 22 (for example, a dried thickness) may be 0.01 mm to 0.20 mm.

In some embodiments of the present disclosure, the adhesive layer 21 may include, but is not limited to, thermosetting or high-solid paste. In some embodiments of the present disclosure, the adhesive layer 21 may be a mixture of polyurethane and a crosslinking agent. In some embodiments of the present disclosure, the adhesive layer 21 may further contain additives (such as flame retardants). In some embodiments of the present disclosure, a thickness of the adhesive layer 21 may be 0.10 mm to 0.25 mm.

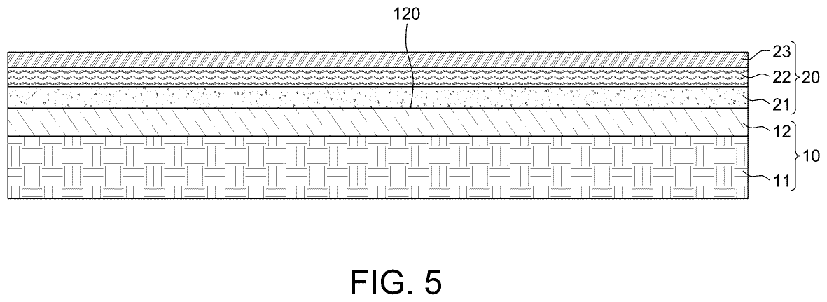

Referring to FIG. 5, the adhesive layer 21 of the second laminate structure 20 is attached to the modified thermoplastic polyolefin film 12 (for example, the corona-treated surface 120) of the first laminate structure 10. In some embodiments of the present disclosure, the attaching process conditions may include: oven temperature: 60° C. to 150° C.; hot air circulation flow rate: 300 rpm to 1800 rpm; conveyor speed of a tablet coating machine (TCM): 6 m/min to 10 m/min; and pressure: 3 kg/m² to 6 kg/m².

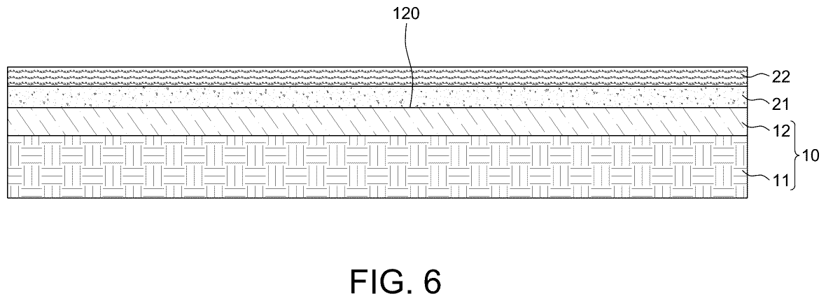

Referring to FIG. 6, the release paper 23 is removed to expose the polyurethane layer 22.

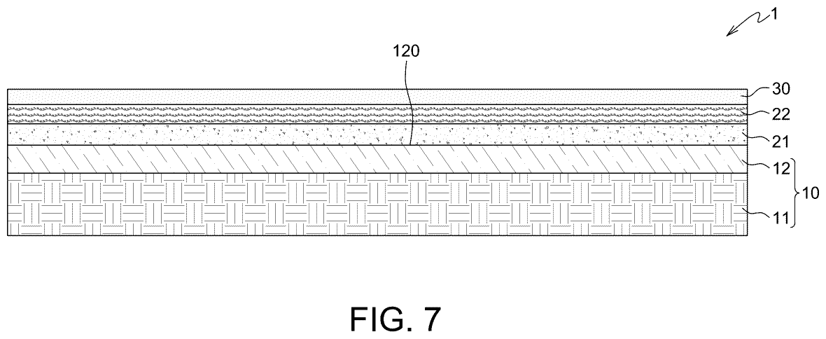

Referring to FIG. 7, a silicon-containing water-based polyurethane surface layer 30 is formed on the polyurethane layer 22 to obtain the wear-resistant artificial leather 1. In some embodiments of the present disclosure, the step of forming the silicon-containing water-based polyurethane surface layer 30 may include:

A silicon-containing water-based polyurethane treatment agent is distributed onto the polyurethane layer 22 through a printing roller with a mesh size of 60 mesh to 250 mesh. In some embodiments of the present disclosure, the silicon-containing water-based polyurethane treatment agent may include, but is not limited to, a silicon-containing water-based polyester polyether copolymer. In some embodiments of the present disclosure, a viscosity of the silicon-containing water-based polyester polyether copolymer may be 60 cps to 800 cps.

The silicon-containing water-based polyurethane treatment agent is dried to form the silicon-containing water-based polyurethane surface layer 30. In some embodiments of the present disclosure, a drying temperature of the silicon-containing water-based polyurethane treatment agent may be 100° C. to 150° C. In some embodiments of the present disclosure, a thickness of the silicon-containing water-based polyurethane surface layer 30 may be 0.01 mm to 0.02 mm.

In the method embodiments illustrated in FIGS. 1 to 7, by performing the surface corona treatment on the modified thermoplastic polyolefin film 12, the adhesion strength between the adhesive layer 21 and the modified thermoplastic polyolefin film 12 can be increased, thereby enhancing the peeling strength of the wear-resistant artificial leather 1 to 15.0 nt/cm. Furthermore, forming the silicon-containing water-based polyurethane surface layer 30 on the polyurethane layer 22 can improve the wear resistance of the wear-resistant artificial leather 1 to reach 30,000 cycles (wear test standard: HES D6511 11-2). On the other hand, the wear-resistant artificial leather 1 obtained by the present invention can be applied to automotive interiors.

The above embodiments are only for illustrating the principles and effects of the present invention, not for limiting the present invention. Those skilled in the art may make modifications and variations to the above embodiments without departing from the spirit of the present invention. The scope of the present invention should be as set forth in the claims of the patent application.

What is claimed is:

1. A manufacturing method of a wear-resistant artificial leather, comprising:
forming a modified thermoplastic polyolefin film and laminating the modified thermoplastic polyolefin film onto a substrate to form a first laminate structure;
forming a polyurethane layer on a release paper and then forming an adhesive layer on the polyurethane layer to form a second laminate structure;
attaching the adhesive layer of the second laminate structure to the modified thermoplastic polyolefin film of the first laminate structure;
removing the release paper to expose the polyurethane layer; and
forming a silicon-containing water-based polyurethane surface layer on the polyurethane layer to obtain the wear-resistant artificial leather.

2. The manufacturing method of claim 1, wherein the step of forming the modified thermoplastic polyolefin film comprises:
forming the modified thermoplastic polyolefin film by a co-extrusion die head;
wherein the modified thermoplastic polyolefin film is a blend of thermoplastic polyolefin and maleic anhydride.

3. The manufacturing method of claim 1, wherein in the step of forming the polyurethane layer on the release paper, the polyurethane layer is a mixture of thermosetting polyurethane, color paste, and a crosslinking agent.

4. The manufacturing method of claim 1, wherein in the step of forming the adhesive layer on the polyurethane layer, the adhesive layer is a mixture of polyurethane and a crosslinking agent.

5. The manufacturing method of claim 1, wherein in the step of attaching the adhesive layer of the second laminate structure to the modified thermoplastic polyolefin film of the first laminate structure, the attaching process conditions include:
oven temperature: 60° C. to 150° C.;
hot air circulation flow rate: 300 rpm to 1800 rpm;
conveyor speed of a coating machine: 6 m/min to 10 m/min; and
pressure: 3 kg/m² to 6 kg/m².

6. The manufacturing method of claim 1, wherein after forming the first laminate structure, the method further comprises:
performing surface corona treatment on the modified thermoplastic polyolefin film so that a surface tension of a corona-treated surface of the modified thermoplastic polyolefin film is greater than or equal to 45 dynes.

7. The manufacturing method of claim 6, further comprising:
attaching the adhesive layer of the second laminate structure to the corona-treated surface of the modified thermoplastic polyolefin film.

8. The manufacturing method of claim 6, wherein a corona power of the corona treatment is 2 KW to 5 KW.

9. The manufacturing method of claim 1, wherein the step of forming the silicon-containing water-based polyurethane surface layer comprises:
distributing a silicon-containing water-based polyurethane treatment agent onto the polyurethane layer through a printing roller with a mesh size of 60 mesh to 250 mesh; and
drying the silicon-containing water-based polyurethane treatment agent to form the silicon-containing water-based polyurethane surface layer.

10. The manufacturing method of claim 9, wherein the silicon-containing water-based polyurethane treatment agent includes a silicon-containing water-based polyester polyether copolymer, and a viscosity of the silicon-containing water-based polyester polyether copolymer is 60 cps to 800 cps.
